(19) United States
(12) Patent Application Publication
(10) Pub. No.: US 2024/0032572 A1
(43) Pub. Date: Feb. 1, 2024

(54) FERMENTED WHITE LENTIL BEVERAGE

(71) Applicant: Massey Ventures Limited, Palmerston North (NZ)

(72) Inventors: Alejandra Acevedo Fani, Palmerston North (NZ); Yiran Wang, Palmerston North (NZ); Arup Nag, Palmerston North (NZ); Debashree Roy, Palmerston North (NZ); Anant Dave, Palmerston North (NZ); Harjinder Singh, Palmerston North (NZ)

(21) Appl. No.: 18/265,312

(22) PCT Filed: Dec. 5, 2021
(86) PCT No.: PCT/IB2021/061346

§ 371 Date: Jun. 5, 2023

(30) Foreign Application Priority Data
Dec. 7, 2020 (AU) 2020904517

(51) Int. Cl. A23L 11/50; A23L 11/60; A23L 11/30

(52) U.S. Cl. CPC A23L 11/50; A23L 11/60; A23L 11/31; A23L 11/33; A23V 2400/123; A23V 2400/249

(57) ABSTRACT

The invention relates to a heat-stable fermented white lentil beverage and process for preparing the same.

### 1. FIELD OF THE INVENTION

The invention relates to a fermented white lentil beverage and a process for preparing said beverage.

### 2. BACKGROUND OF THE INVENTION

Plant-based beverages are an increasing popular alternative to dairy products due to medical reasons such as lactose intolerance and milk allergies. Consumer concerns about cow milk hormones, animal welfare issues and the detrimental environmental effects of dairying have also driven global demand for plant-based meat/dairy alternatives.

Plant-based milk substitutes are water extracts of legumes, nuts, seeds, cereals or pseudocereals that resemble cow's milk in appearance. Fermentation of plant-based milk substitutes results in beverages such as drinking yogurts and non-dairy alternatives to yogurt and cheese.

Plant-based milk substitutes comprise colloidal suspensions or emulsions consisting of dissolved and disintegrated plant material. They are generally prepared by grinding the plant material into a slurry and straining it to remove coarse particles. Enzymes such as amylases may be added to remove starch which forms a thick slurry when the material is heated above gelatinisation temperature. Standardisation and/or addition of other ingredients such as sweeteners, oil, flavouring, vitamins and stabilisers may take place, followed by homogenisation and pasteurisation/UHT treatment to improve shelf stability.

Unfortunately, many plant-based milk substitutes suffer from a number of problems that reduce their consumer appeal.

Firstly, legume-based products tend to smell and taste beany or earthy, mostly due to volatile compounds such as n-hexanal and n-hexanol that are generated by oxidation of plant lipids. Many consumers consider these off-flavours to be undesirable. Other sensory issues include an objectional aftertaste caused by polyphenols such as flavonoids; a greenish, greyish or brownish colour; a chalky or sandy texture; and a thin mouthfeel.

Secondly, many plant-based milks are nutritionally inferior to cow's milk. In particular, the protein content of these milk substitutes can be quite low. Generally, only selected soy-based milk substitutes reach the protein levels found in cow's milk. Plant proteins are often low quality, poorly digestible and limited in essential amino acids. In addition, vitamins D and B₁₂ may be present in only low levels or even absent.

A third problem is that many plant-based milk substitutes coagulate (or curdle) when heated. When heated proteins unfold, the non-polar amino acid residues are exposed to water, increasing the surface hydrophobicity of the protein. This enhances protein-protein interactions making the proteins aggregate. Random, fast aggregation often results in coagulation (i.e., precipitation leading to separation of the water and protein phases). Heat-induced coagulation is a problem because heating in the form of pasteurisation or ultra-high temperature (UHT) processing is routinely used to extend the shelf-life of plant-based beverages.

Lactic acid fermentation (fermentation by lactic acid bacteria) is often used to alleviate some of the sensory and nutritional issues found in plant-based milk substitutes. Fermentation can lessen the beany and other off-flavours and result in desirable volatile flavours. Such fortification by natural vitamin-producing microorganisms is considered a more desirable solution than synthetic fortification.

Accordingly, fermented plant-based beverages such as yogurt and kefir often have better sensory and nutritional properties than non-fermented plant-based milk substitutes.

Unfortunately, the problem of coagulation is particularly acute in low pH products such as fermented plant-based beverages. Plant-based milk substitutes are stable colloidal suspensions at neutral pH. However, as the pH lowers towards the isoelectric point of the proteins, the net protein charge becomes zero (in the absence of repulsive forces) destabilising the suspension. Destabilisation results in loss of homogeneity and protein precipitation.

The strong tendency of low pH fermented plant-based beverages to coagulate on heating means that they generally need to be formulated with stabilisers such as low-methoxy pectin and/or gellan gum. These agents stabilize the gel network, preventing coagulation and syneresis. Consumers consider the presence of stabilisers to be undesirable, leading many manufacturers seeking alternatives that omit their use.

Accordingly, there is a need in the art for fermented plant-based milk substitutes that are heat stable and able to undergo pasteurization or UHT processing, without the attendant problems of protein aggregation and coagulation.

It is therefore an object of the invention to provide a process for preparing a fermented plant-based beverage that overcomes at least some of the disadvantages in the art as set out above and/or that provides the public with a useful choice.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### 3. SUMMARY OF THE INVENTION

The inventors have developed a process for preparing a fermented plant-based beverage that is highly palatable, relatively high in protein and heat-stable.

In one aspect the invention relates to a process for preparing a fermented white lentil beverage, the process comprising:
(a) soaking white lentils in water for at least about 30 min,
(b) removing the water from step (a) and adding new water to provide a mixture of white lentils and water in a wt ratio of about 1:20 to about 1:1,
(c) cooking the mixture of step (b) under pressure for about 10 to about 40 min,
(d) forming a paste from the cooked lentil mixture and adjusting the solid content of the paste to be about 7 to about 20 wt % before wet milling the resulting slurry,
(e) filtering the wet milled slurry of step (d) through a 10-150 micron membrane and incubating the slurry with amylase enzyme at a temperature at which the enzyme is active to reduce the starch content of the slurry,
(f) inactivating the amylase enzyme by heating, to produce a white lentil beverage, and,
(g) inoculating the white lentil beverage with a lactic acid bacterial culture and incubating until the beverage reaches a pH of about 4.3 to about 4.6.

In one embodiment the white lentils are soaked for about 30 to 60 minutes in step (a). In one embodiment the white lentils are whole lentil seeds and the temperature of the water in step (a) is about 95° C.

In one embodiment, the white lentils are crushed lentil seeds (white lentil flour) and the temperature of the water in step (a) is about 4 to about 50° C., preferably about 30° C.

In one embodiment the wt ratio of white lentils to water in step (a) is about 1:20 to about 1:1, preferably 1:10 to about 1:2, more preferably about 1:5 to about 1:3.

In one embodiment the wt ratio of white lentils to water in step (b) is about 1:10 to about 1:2, preferably about 1:5 to about 1:3.

In one embodiment the mixture of step (b) is cooked at about 100 to about 140° C. in step (c), preferably at about 110 to about 130° C., more preferably at about 115 to about 125° C.

In one embodiment the mixture of step (b) is cooked for about 15 to about 30 min in step (c).

In one embodiment the white lentil paste in step (d) is adjusted to be about 9 to about 18 wt % solids, preferably about 10 to about 15 wt % solids. In one embodiment the white lentil paste in step (d) is adjusted to be about 13 wt % solids.

In one embodiment the white lentil paste in step (d) is wet milled in a colloid mill.

In one embodiment about 0.01 w/v % to 0.5 w/v % amylase enzyme is added in step (e), preferably 0.1 w/v %. In one embodiment the amylase enzyme is AMG 1100. In one embodiment, the slurry is heated at about 65° C.

In one embodiment the slurry of step (d) is filtered through a 100 micron membrane in step (e). In one embodiment the starch content is reduced to less than about 5 wt % in step (e).

In one embodiment, about 0.1 to about 4 w/v % edible oil is added prior to or following step (f). In one embodiment, the white lentil slurry and edible oil are homogenised at 200-300.

In one embodiment, the amylase enzyme is inactivated by heating at 90-100° C. for 3-5 min in step (f).

The invention also relates to a fermented beverage prepared according to the process of the invention.

In one aspect the invention relates to a fermented white lentil beverage of pH of about 4.3 to about 4.6, comprising about 5 to about 15 wt % carbohydrate, about 2 to about 4.5 wt % edible oil and about 1.0 to about 2.5 wt % white lentil protein.

In one embodiment the fermented white lentil beverage comprises about 7 to about 10 wt % carbohydrate. In one embodiment the fermented white lentil beverage comprises about 2 to about 3.5 wt % edible oil.

In one embodiment the fermented beverage comprises about 1.2 to about 2.0 wt % white lentil protein. In one embodiment, the fermented beverage comprises about 1.5 to about 1.8, 1.9 or 2.0 wt % white lentil protein.

In one embodiment, the edible oil is vegetable oil.

In one embodiment the white lentil protein is substantially non-aggregated.

In one embodiment the average particle size is less than 100 μm.

In one embodiment the fermented white lentil beverage is dairy-free.

In one embodiment the fermented white lentil beverage is stable for at least 6 months when stored at ambient temperatures. In one embodiment the fermented beverage is stable for at least 9 months when stored at ambient temperatures. In one embodiment the fermented beverage is stable for at least 12 months when stored at ambient temperatures.

In one embodiment the fermented beverage does not contain any added stabilising agents.

Various embodiments of the different aspects of the invention as discussed above are also set out below in the detailed description of the invention, but the invention is not limited thereto.

Other aspects of the invention may become apparent from the following description which is given by way of example only.

### 4. BRIEF DESCRIPTION OF THE FIGURES

The invention will now be described by way of example only and with reference to the drawings in which:

FIG. 1 is a graph showing the development of gel strength (G′) over the fermentation process described in Example 5.

FIG. 2 is a graph showing the final storage modulus (G′) values of fermented plant-based beverages after 6 hours of fermentation as described in Example 5.

FIG. 3a is a graph showing the change in particle size distribution of the white lentil beverage during the fermentation process described in Example 5.

FIG. 3b is a graph showing the change in particle size distribution of a pea beverage due to the fermentation process described in Example 5.

FIG. 3c is a graph showing the change in particle size distribution of a chickpea beverage due to the fermentation process described in Example 5.

FIG. 3d is a graph showing the change in particle size distribution of a mung bean beverage due to the fermentation process described in Example 5.

FIG. 4 is a series of photographs of the samples of prepared in Example 5 before and after the fermentation process.

FIG. 5 is a graph showing changes in the particle size distributions of the white lentil beverage due to heat treatment at 95° C. for different time durations, as set out in Example 6.

FIG. 6 is a graph showing changes in the particle size distributions of the mung bean beverage due to heat treatment at 95° C. for different time durations, as set out in Example 6.

FIG. 7 is a photograph showing syneresis in the heat-treated fermented mung bean beverage samples of Example 6.

FIG. 8 is a photograph showing absence of any visibly detectable syneresis in the heat-treated fermented white lentil beverage samples of Example 6.

FIG. 9 is a graph showing the change in viscosity of the fermented white lentil beverage due to heat treatment followed by overnight storage, as set out in Example 6.

FIG. 10 is a graph showing the change in viscosity of the fermented mung bean beverage due to heat treatment followed by overnight storage, as set out in Example 6.

### 5. DETAILED DESCRIPTION OF THE INVENTION

### Definitions and Abbreviations

As used herein the term “comprising” means “consisting at least in part of”. When interpreting each statement in this specification that includes the term “comprising”, features other than that or those prefaced by the term may also be present. Related terms such as “comprise” and “comprises” are to be interpreted in the same manner.

The term “about” as used herein means a reasonable amount of deviation of the modified term such that the end result is not significantly changed. For example, when applied to a value, the term should be construed as including a deviation of +/−5% of the value.

The term “white lentil” as used herein refers to the dehulled lens-shaped seed of the Vigna mungo plant, either in whole or crushed form (lentil flour). The white lentil seed with the hull intact is also known as the “black lentil”, “black gram”, “urad bean”, “minapa pappu”, “mungo bean” and “black matpe bean”. “White lentil protein” is the protein present in the dehulled seed, or that originated from the dehulled seed.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

Whenever a range is given in the specification, for example, a temperature range, a time range, or a composition range, all intermediate ranges and subranges, as well as all individual values included in the ranges given are intended to be included in the disclosure. In the disclosure and the claims, “and/or” means additionally or alternatively. Moreover, any use of a term in the singular also encompasses plural forms.

### 5.2 the Process of the Invention

The inventors have developed a process for preparing a fermented plant-based beverage that is highly palatable, relatively high in protein and heat-stable. The beverage comprises the fermentation products formed by culturing lactic acid bacteria in an extract of the dehulled black lentil legume, referred to herein as “white lentil”.

As disclosed herein, the inventors have surprisingly found that fermentation of such extracts produces a beverage with unique properties.

White lentils are prepared by dehulling black lentils/gram. Dehulling is the removal of the seed coat. Black lentils/gram are mostly used for culinary purposes and are not commonly used in plant-based beverage/milk substitutes. Compared to the common lentils grown and available (red, light-medium-dark green, yellow Mexican, Canadian beluga), the dehulled black lentil (white lentil) is whiter in colour and has a comparatively sweeter, more mellow, and creamy taste profile.

The process used to prepare the fermented beverage of the invention is similar to that of other plant-based milk substitutes, but the end product is remarkably different, due to certain unique properties of the white lentil itself that have been identified and manipulated by the inventors.

In step (a) of the process of the invention, white lentils are soaked for at least 30 minutes. Generally, soaking for about 30-60 minutes is optimal. Longer soaking times may lengthen the processing time without providing any tangible benefit.

Where the white lentils are in whole (seed) form, the soaking water is preferably near boiling. Near boiling temperature means about 90° C. or above. In one embodiment whole white lentils are soaked in water of about 95° C.

Where the white lentils are in crushed form (lentil flour), the temperature should be lower than about 50° C. Higher temperatures may cause gelatinisation of the flour.

In one embodiment crushed white lentils are soaked in water of about 4 to about 50° C., preferably about 30° C.

In one embodiment the ratio of the lentils to water is about 1:20 to about 1:1, preferably 1:10 to about 1:2, more preferably about 1:5 to about 1:3.

The soaking step (a) deactivates lipoxygenase and hydroperoxide lyase enzymes. These enzymes produce oxidised reaction products with beany flavours. Both enzymes are activated during the hydration and crushing of legumes but can be inactivated by heating at 72° C. or higher.

In step (b) the soaking water is removed from the hydrated white lentils and discarded. This step also removes other water-soluble substances such as flavonoids and phytochemicals. Some of these compounds are known to be responsible for the beany and raw/grassy flavours found in plant-based milks.

The soaking water is then replaced with fresh water, to provide a hydrated lentil mixture with a weight ratio of white lentils to water of 1:20 to about 1:1. In one embodiment the wt ratio of white lentils to water in step (b) is about 1:10 to about 1:2, preferably about 1:5 to about 1:3. The ratio of lentils to water should allow for the water that has been absorption into the lentils in step (a), ie the ratio should be calculated using the dry weight of white lentils added in step (a).

The lentil mixture is then cooked under pressure for about 10 to about 40 minutes, preferably about 15 to about 30 minutes. In one embodiment the mixture of step (b) is cooked at about 100 to about 140° C. in step (c), preferably at about 110 to about 130° C., more preferably at about 115 to about 125° C.

In one embodiment the hydrated white lentils are cooked in a pressure vessel equipped with direct steam injection capability. In one embodiment a steam injection is used to heat the contents of the pressure vessel to about 115-125° C. before the closed system is maintained for 15-30 min.

Pre-processing steps (a) to (c) are very important, as demonstrated in Examples 2 and 3. These processes decrease the raw taste profile and improve the digestibility of the lentil proteins. They also soften the whole lentils, making it easier to form a pastes and slurries of this lentil material. Omitting any of steps (a) to (c) from the process will result in an inferior product.

Following pre-processing steps (a) to (c), the soft, hydrated white lentils are then subjected to a milling process.

In step (d) a paste is first formed from the cooked lentil mixture. Where a lentil flour has been used, the paste forms spontaneously.

Where whole white lentils are used, they are subjected to a two-step milling process. The hydrated whole white lentils are first crushed to form a paste. In one embodiment the first milling comprises crushing the whole white lentils in a food processor. This first milling step reduces the size of the particles, making a lentil paste that is suitable for wet milling, in the second milling step.

The solid content of the white lentil paste is adjusted to be about 7 to about 20 wt % by the addition of water to form a slurry. In one embodiment the white lentil paste in step (d) is adjusted to be about 9 to about 18 wt % solids, preferably about 10 to about 15 wt %. In one embodiment the white lentil paste in step (d) is adjusted to be about 13 wt % solids.

The water content of the white lentil slurry at this stage is important. A lower water content will make the slurry too viscous while a higher water content may induce instability in the colloid suspension, in addition to lowering the protein content.

The white lentil slurry is then wet milled. Wet milling is a process in which particles in a colloid suspension are dispersed in a liquid by shearing, by impact or by attrition. The mill is charged with media such as small beads or spheres and activated by a high-speed agitator shaft to separate the individual particles. Rotation of the agitator transmits kinetic energy to the media. This energy acts on solids suspended in the liquid of the colloid suspension to crush or tear them apart. The ultimate particle size depends on the size of the grinding media, the time the slurry spends in the grinding chamber, the number of passes through the mill and the speed of agitation.

Wet milling is an important step, irrespective of the type of white lentils used (whole or crushed). A finely ground white lentil flour will have a small average particle size but hydration of the lentil proteins during the soaking and cooking process will increase the particle size.

Wet milling in step (d) may be achieved using any suitable device known in the art, including but not limited to a colloid mill, conical mill or high-shear disperser. A person skilled in the art will be able to select an appropriate wet mill and conditions for its use, to achieve a smooth lentil slurry following the guidance provided in the present disclosure combined with what is known and used in the art.

In one embodiment, the white lentil slurry is wet milled in a colloid mill. A colloid mill is a device used to reduce the size of solid particles in a suspension in a liquid by applying high levels of hydraulic shear to the liquid.

In step (e) the white lentil slurry is filtered through a 10-150 micron membrane either before or after being incubated with an amylase enzyme, preferably after.

Filtration improves the mouth feel of the final product. Filtration can be accomplished by passing the slurry under pressure through any filtration device with a pore size from 10 μm to 150 μm. Suitable filtration devices include porous membranes, strainers and filter presses.

The size of the filtering membrane is important. Filtration with a 10-150 micron membrane removes larger particles that are easily perceivable in sensorial tests and are considered unfavourable as they give rise to grittiness (https://onlinelibrary.wiley.com/doi/abs/10.1111/j.1745-4603.1995.tb00804.x.

Use of a filtering membrane with a smaller pore size would yield a smoother product but could adversely affect the yield of the product.

Wet milling followed by filtration both reduces the average size of the particles in the beverage and ensures a narrow size distribution. These properties are important features of the white lentil protein particles present in the beverage of the invention, contributing to its unique heat stability.

In one embodiment, the white lentil slurry is passed through a 100 μm porous membrane. Typically, industrial scale filter press equipment is used for this purpose.

The wet milled slurry is also treated with amylase enzyme under controlled pH and temperature conditions. While amylase can be added prior to or following filtration, the former is preferred. Where amylase is added prior to filtration, it is added to the wet milled slurry made in step (d).

Amylase is used to hydrolyse the starch present in the lentil slurry into derivative products such as dextrin and dextrose. This step also reduces the viscosity and grittiness of the product. Another objective of this step is to make dextrose available as a fermentation substrate for the bacterial cultures used later in the process. Yogurt-producing bacterial cultures break down the lactose present in milk into glucose and then utilize the glucose to propagate while producing acid and flavour compounds. This starch hydrolysis step helps avoid the need of additional supplementation of carbohydrates as substrates for the fermenting cultures, thereby making the product ingredient label cleaner.

In one embodiment, the amylase used to breakdown the starch is selected from the group consisting of alpha-amylase, beta-amylase and amyloglucosidase (AMG).

Different commercial grade amylase enzymes have different optimal pH and temperature combinations for optimal activity. For example, AMG 1100 may be used to break down the starch content at an optimal temperature of 50-70° C. and optimal pH of 4.5 to 7.0.

In one embodiment about 0.01 w/v % to 0.5 w/v % amylase enzyme is added in step (e), preferably 0.1 w/v %. In one embodiment the amylase enzyme is AMG 1100. In one embodiment, the slurry is heated about at 65° C.

The actual amount of time needed for enzyme treatment will vary based on the quantity of enzyme added, starch content in the slurry, temperature and pH. A person skilled in the art would understand how to vary the pH and/or temperature for optimal activity and how to compensate for non-optimal conditions based on the disclosure provided herein in combination with what is known and used in the art.

In one embodiment, the pH is not adjusted and the reaction time is extended, to allow for sufficient breakdown of starch.

In one embodiment, the amylase enzyme is incubated with the wet milled white lentil slurry until the starch content of the slurry is less than 5 wt %, measured on a dry basis.

A person skilled in the art would understand how to measure the starch content of the slurry, for example, by determining the change in glucose concentration using a glucose oxidase/peroxidase reagent. Standard analytical assays for pure starch determination are defined in AOAC 996.11 and 2014.10.

In one embodiment, 0.1% w/v % AMG 1100 was added to the 15% (total solids) white lentil slurry and the mixture heated at 65° C. for 5 hours.

When most of the starch is broken down, or the slurry reaches a desirable viscosity, the amylase is inactivated by heating.

In one embodiment the white lentil slurry is filtered before being treated with amylase enzyme. In another embodiment the white lentil slurry is filtered after being treated with amylase enzyme. The latter option is preferred.

Following the filtration and starch hydrolysis carried out in step (e), the white lentil slurry may be homogenised with an edible oil. This optional step may be carried out either prior to or following inactivation of the amylase enzyme in step (f).

The essential macronutrients of any formulated beverage are proteins, carbohydrates and lipids with good nutritional quality. Dry white lentils contain about 20-25 wt % proteins; only 2 wt % lipids with the remainder mostly comprising carbohydrates. Therefore, a 10 wt % white lentil slurry contains only about 0.2% lipid, which can be increased by supplementing from another source.

Any edible oil (including vegetable, fish and animal oils) can be used for this purpose depending on the desired fatty acid profile of the white lentil beverages. Generally, the edible oil will be a vegetable oil. In one embodiment the oil is selected from the group consisting of soybean oil, canola oil, coconut oil, sunflower oil, peanut oil, olive oil, safflower oil, rapeseed oil, corn or maize oil, cottonseed oil or mixtures thereof.

The amount of oil to be added depends on the intended categorization of the final product as low-fat or full-fat one. In one embodiment about 0.1 to about 4 w/v % edible oil is added prior to or following step (f), preferably about 0.1 to about 3 w/v %.

Homogenization of an oil-containing plant-based beverage produces a stable oil-in-water emulsion in the presence of a suitable emulsifying agent.

Milk and egg proteins in their natural forms act as excellent emulsifiers in various liquid and semi-solid applications. Generally, plant proteins do not have the same properties.

In the current invention however, the white lentil protein has been found to successfully emulsify the oil component of the beverage to form a stable emulsion with no visible phase separation.

In one embodiment homogenization is carried out at a pressure ranging from 200 to 300 Pa. In one embodiment, the white lentil slurry is homogenised at 250 Pa to form an emulsion.

Alternatively, the process may omit the addition of oil and the homogenisation step.

Following step (e) the white lentil slurry is heated to deactivate the amylase enzymes. In one embodiment the white lentil slurry is heated to about 90-95° C. for about 3-5 minutes.

In practice, where oil has been added, homogenization and subsequent heat treatment of the final mix for enzyme deactivation are carried out simultaneously in a continuous HTST type heat exchanger connected with the homogenizer.

The white lentil beverage formed by the above process is then fermented with a lactic acid bacterial culture to provide a fermented white lentil beverage such as a drinking yogurt, probiotic drink or kefir.

The nature of the fermented beverage obtained depends on the particular lactic acid bacterial culture used in the fermentation process. In one embodiment, the lactic acid bacteria is selected from the group consisting of Lactococcus lactis, Lactobacillus species, Streptococcus thermophilus, Bifidobacterium species, and Leuconostoc species.

In one embodiment the white lentil beverage is inoculated with a commercial yogurt culture comprising selected strains of Lactobacillus bulgaricus and Streptococcus thermophillus bacteria.

Yogurt cultures break down the carbohydrates (lactose, in the case of milk) to produce the flavouring compounds responsible for the unique flavour profile of yogurt. In the process of the invention described herein, the same types of flavours are expected to be produced. These flavours help mask any residual beany flavour and contribute to a new hybrid flavour profile. This new flavour profile has much better sensorial properties compared to the unfermented white lentil beverage (Example 5). By selecting and combining with other type of cultures, for example, kefir cultures, cheese cultures, probiotics and the like, more novel flavour profiles can be generated.

The selection of a particular strain depends on the intended characteristics of the final product.

The inoculated white lentil beverage is incubated with lactic acid bacterial culture until the desired acidity level is reached (pH about 4.30 to 4.60), providing a fermented white lentil beverage of the invention.

A person skilled in the art would know how much culture to use and the best temperature at which to incubate that particular culture, to produce a fermented white lentil beverage of the invention. A person skilled in the art would also know how long to incubate the culture, to achieve the required pH, without creating an unfavourable taste profile.

If the fermented white lentil beverage is intended to be stored under refrigeration, it can now be packed and chilled to below 4° C. to arrest further growth of the cultures. If an ambient stable product is desired then the fermented white lentil beverage of the invention is further heat treated to achieve commercial sterility before being cooled to room temperature and aseptically packed into containers using specialty equipment designed for this purpose.

For example, the fermented white lentil beverage of the invention could be heated at 74° C. for 20 sec in a HTST pasteurizer. Unlike comparable low pH plant-based beverages, the fermented white lentil beverage of the invention is not negatively affected by this type of heat treatment.

### 5.3 the Fermented White Lentil Beverage of the Invention

The process of the invention produces a fermented white lentil beverage with unique properties. In particular, the beverage is very stable even when heated.

Plant-based milk substitutes are colloidal systems formed by large, dispersed particles such as fat globules, solid particles from raw materials, proteins and starch granules that are suspended in an aqueous liquid phase (the dispersion medium). The stability of a plant-based milk substitute depends on the size of the particles in the dispersed phase. Larger particles are more inclined to sediment, leading to separation of the dispersed phase from the dispersion medium. Aggregation of proteins increases their particle size, causing them to separate out from the dispersion medium.

The fermented white lentil beverage of the invention is unusual in that its proteins have far less tendency to aggregate than those of other fermented plant-based products or even fermented dairy-based products.

Fermented dairy-based products such as yogurt have a tendency to undergo syneresis during storage if the protein-water network is not stabilized with a stabilising agent. In the absence of a stabilising agent, milk proteins tend to aggregate and form a coagulated mass near the isoelectric point (pH 4.5) even under refrigerated conditions.

Lactic acid fermentation of a white lentil beverage does not generate coagulated protein. Therefore, the product does not need to be stabilised with a hydrocolloid agent such as pectin and/or gellan gum, as is the case for both other fermented plant-based milk substitutes and fermented dairy products.

Even more unusually, the fermented white lentil beverage of the invention can be subjected to the type of heat treatment needed to destroy the fermenting cultures and other undesired microorganisms, to produce a shelf-stable product that does not curdle. As demonstrated in Example 6, this property is not found in similar fermented plant-based beverages, even when prepared using other varieties of lentils.

Without being bound by theory, it is believed that the unusual heat stability of the beverages of the invention results from the combination of (a) the inherent characteristics of white lentil proteins (for example, their charge density distribution and surface hydrophobicity) and (b) modification of the lentil particle structure during the process of the invention, in particular the reduction in average particle size and narrowing of particle size distribution achieved by wet milling and filtration of the cooked white lentil material. Other fermented white lentil beverages, such as those described in US 2016/0192682, do not share these properties and so are not stable at high temperatures.

The high heat stability at low pH demonstrated by the fermented white lentil beverage of the invention means that it can be stored for long periods at ambient temperature, without the need for hydrocolloid stabilisers.

Comparable products, including other fermented lentil milk substitutes must include hydrocolloid stabilisers such as starch, pectin, carrageenan, guar gum, xanthan gum etc, which are generally considered undesirable to consumers.

In addition to its unique stability, the fermented white lentil beverage of the invention has reduced viscosity relative to comparable products (see Example 6), a very mild beany flavour, mild sweet taste and smooth mouthfeel. Its flavour profile closely resembles that of fermented dairy products such as, yogurt, cultured milk or drinking yogurt.

Another advantage is the relatively high protein content of the fermented white lentil beverage of the invention (up to about 2.5 wt %). Commercially available plant-based beverages such as soy or almond milk generally contain about 0.8 to 1.0 wt % protein.

A further advantage is the colour of the fermented white lentil beverage of the invention. As shown in Example 5, this product is much whiter than comparable fermented plant-based beverages, giving it even further appeal to consumers.

In one aspect the invention provides a fermented white lentil beverage of pH of about 4.3 to about 4.6, comprising about 5 to about 15 wt % carbohydrate, about 2 to about 4.5 wt % edible oil and about 1.0 to about 2.5 wt % white lentil protein.

In one embodiment the fermented white lentil beverage comprises about 7 to about 10 wt % carbohydrate. In one embodiment the fermented white lentil beverage comprises about 2 to about 3.5 wt % edible oil.

In one embodiment the fermented beverage comprises about 1.2 to about 2.0 wt % white lentil protein. In one embodiment, the fermented beverage comprises about 1.5 to about 1.8, 1.9 or 2.0 wt % white lentil protein.

In one embodiment, the edible oil is a vegetable oil.

In one embodiment the white lentil protein is substantially non-aggregated.

In one embodiment the average particle size is less than 100 μM.

In one embodiment the fermented white lentil beverage is dairy-free.

In one embodiment the fermented white lentil beverage is stable when heated to about ° C. for about 3-5 minutes.

In one embodiment the proteins of the fermented white lentil beverage do not substantially aggregate when heated to about 90-95° C. for about 3-5 minutes.

In one embodiment the fermented white lentil beverage is stable for at least 6 months when stored at ambient temperatures. In one embodiment the fermented beverage is stable for at least 9 months when stored at ambient temperatures. In one embodiment the fermented beverage is stable for at least 12 months when stored at ambient temperatures.

In one embodiment the fermented beverage does not contain any added stabilising agents, for example agar-agar, guar gum, microcrystalline cellulose, modified starch and the like.

In one embodiment the fermented white lentil beverage is neutralized back to pH 6.8-7.0 by the addition of food grade alkaline chemicals to produce a neutral pH beverage with a modified taste profile.

Various aspects of the invention will now be illustrated in non-limiting ways by reference to the following examples.

### 6. EXAMPLES

### Example 1: Preparation of a Fermented White Lentil Beverage of the Invention

Dehulled black lentil/gram (450 g) was soaked in 2 L of near boiling water for 1 hour, then cooked under pressure at 121° C. for 15 min. The cooked lentils were then crushed in a food processor. The solid content was adjusted to 15 wt % by addition of water before the lentil paste was passed through a colloid mill to form a smooth slurry. The slurry was then filtrated through a 100 micron PP cloth filter. The filtrated slurry comprised about 8.5 wt % solid and about 1.9 wt % protein. AMG 1100 (0.1 w/v %) was added at 65° C. and incubated for 5 hrs. Sunflower oil (3 w/v %) was added and the mixture homogenised at 250/50 bar. Finally, the homogenised slurry was heated at 90-95° for 3-5 minutes to inactive the enzyme and to pasteurise the product.

The homogenised mixture was inoculated with a commercial yogurt culture comprising selected strains of Lactobacillus bulgaricus and Streptococcus thermophillus bacteria at 42° C. for 6 hours to give a fermented white lentil beverage of the invention. The pH of the beverage was 4.30.

The fermented white lentil beverage of the invention comprises a plant-based substitute for dairy-based drinking yogurt.

A portion of the fermented white lentil beverage of the invention was heated at 74° C. for seconds, cooled and aseptically filled into sterile containers, to provide a shelf-stable plant-based substitute for dairy-based drinking yogurt.

### Example 2: Effect of Pre-Processing Steps on the Fermented White Lentil Beverage

The effect of (a) soaking the whole white lentils at near boiling temperature and (b) the high pressure-high temperature treatment, on the flavour and taste profile modulation of the unfermented white lentil composition was evaluated using a sensory test by trained panellists.

A white lentil beverage (Sample A) was prepared in accordance with steps (a) to (g) of the process of the invention, as set out in Example 1

Two analogous products (Samples B and C) were prepared using the same process but for Sample B the soaking was done using water at room temperature only. For Sample C, the soaking water was at room temperature and the soaked beans were not subjected to the high temperature, high pressure cooking process of step (b). The processes used are summarised in Table 1 below.

TABLE 1
Process of preparing white lentil beverages for assessing
soaking and cooking pre-processing steps

| Sample A | Sample B | Sample C |
|---|---|---|
| 450 g dehulled black | 450 g dehulled black | 450 g dehulled black |
| lentil beans | lentil beans | lentil beans |
| 2 L water | 2 L water | 2 L water |
| soak 1 hour | soak 1 hour at | soak 1 hour at |
| (95° C.) | room temperature | room temperature |
| Discard the | Discard the | Discard the |
| soaking water and | soaking water and | soaking water and |
| add fresh water to give | add fresh water to give | add fresh water to give |
| a w/w ratio of white | a w/w ratio of white | a w/w ratio of white |
| lentils to water of 1:4 | lentils to water of 1:4 | lentils to water of 1:4 |
| Pressure cook | Pressure cook | — |
| at ~121° C. | at ~121° C. | |
| for 15 min | for 15 min | |

Crush the cooked white lentil with a food processor
and add water to give 3000 g total
weight (solid:water = 15:85)
Pass through colloid mill with minimum gap size
Heat the slurry to 65° C.
Add 3 g AMG 1000 (0.1 w/v %) and keep it 5 hours
Filter the slurry with 100 μm filter bag, collect filtrate
Add 40 g sunflower oil (2 w/v %)
Adjust temperature to 55-65° C.
Pass through homogenizer at 250 Pa
Heat the slurry to 90-95° C. for 3-5 min to
inactivate the AMG and pasteurization

The sensory evaluation was performed by asking the panellists to taste the samples and judge for any beany flavour, grassy/rawness and/or bitterness. The panellists were asked to score the samples on a scale of 1 to 5 with 1 being the weakest and the 5 being the strongest profile. The intensity of flavour from weak to strong is expressed by 1-5. The results are shown in the Table 2 below.

TABLE 2
Sensory evaluation score of the white
lentil beverages of Example 2

| | Sample A | Sample B | Sample C |
|---|---|---|---|
| Beany flavour | 2 | 3 | 4 |
| Grassy | 1 | 2 | 5 |
| Bitterness | 1 | 2 | 4 |

The results indicate that hot water soaking followed by pressure cooking helps reduce the common undesirable flavour and taste attributes in the white lentil beverage prior to fermentation. Sample A, prepared according to the process of the invention, was found to have the weakest beany flavour. Sample C retained the intrinsic beany, grassy flavours and bitterness typical of many plant-based beverages. Sample B was found to have a medium level of beany flavour.

The beany and grassy flavour result from volatile compounds, such as aldehyde, ketones, and furans, which are produced by the oxidation of lipids by lipoxygenase and hydroperoxide lyase in the lentil. This oxidation occurs when the white lentils are hydrated and subsequently crushed. The process of the invention uses soaking and heating under pressure to inactive the lipoxygenase and hydroperoxide lyase at the beginning of the process which reduces the beany and grassy flavour in the pre-fermented white lentil composition. As would be assumed by a person skilled in the art, this reduction in beany/grassy flavours would also be observed in the fermented white lentil food beverage produced by carrying out the remaining steps of the process.

### Example 3: Effect of Discarding Soaking Water on the Fermented White Lentil Beverage

In order to determine if discarding the soaking water and replenishing it with fresh water during the pressure cooking process would reduce the undesirable beany and grassy flavour in the final product, two set of samples were prepared. Sample A was prepared in accordance with steps (a) to (g) of the process of the invention as set out in Example 1 (including discarding the soaking water and adding fresh water to give a ratio of white lentils to water of 1:5-1:1). Sample B was prepared using an analogous process but discarded only the volume of soaking water needed to give a ratio of white lentils to water of 1:4).

The preparation processes used are summarised in Table 3 below.

TABLE 3
Process of preparing white lentil beverages for
assessing pre-processing step of discarding water

| | |
|---|---|
| Sample A | Sample B |

450 g dehulled dry black lentil beans
2000 g water soak for 1 hour (95° C.)

| | |
|---|---|
| Discard the soaking water and | — |
| add fresh water to give a ratio | |
| of white lentils to water of 1:4 | |

Pressure cook at ~121° C. for 15 min
Crush the cooked white lentil with a food processor and add water
to give 3000 g total weight (solid:water = 15:85)
Pass the slurry through colloid mill with minimum gap size
Heat the slurry to 65° C.
Add 3 g AMG 1000 (0.1 w/v %) and incubate for 5 hours
Filter the slurry with 100 μm filter bag, collect filtrate
Add 40 g sunflower oil (2 w/v %)
Adjust temperature to 55-65° C.
Pass through homogenizer at 250 Pa
Heat the slurry to 90-95° C. for 3-5 min to
inactivate the AMG and pasteurization

The sensory evaluation protocol was same as described in the Example 2 and is summarised in Table 4 below.

TABLE 4
Sensory evaluation score of the white
lentil beverages of Example 3

| | Sample A | Sample B |
|---|---|---|
| Beany flavour | 2 | 2 |
| Grassy | 1 | 2 |
| Bitterness | 1 | 2 |

The results shown in Table 4 indicate that replacing the soaking water had no impact on the beany flavour but helped in reducing the grassy flavour and bitterness in the final beverage. Without being bound by theory, it is thought that these undesirable flavours are due to the presence of certain water-soluble off-flavour compounds in the white lentil such as aldehydes, ketones, and furans, which dissolved fully into the soaking water.

As would be assumed by a person skilled in the art, this reduction in grassy flavours and bitterness would also be observed in the fermented white lentil beverage produced by carrying out the remaining steps of the process.

### Example 4: Effect of Fermentation

In order to determine the effect of fermentation on the overall sensory profile of the white lentil beverage, Sample A from Example 3 was fermented with 0.024% (w/v) inoculum of a commercial yogurt culture (YC-380, Che Hansen, Denmark) which comprised the strains of Lactobacillus bulgaricus and Streptococcus thermophilus.

The fermentation was carried out by incubating the beverage at 45° C. for 8 hours. Samples were taken out every 2 hours, at the time intervals of 2 h, 4 h, 6 h, and 8 h.

The pH was measured at each time point and the results are shown in Table 5.

The fermented white lentil beverage was then offered to the evaluating panellists for extensive sensorial tests, including beany flavour, grassy and bitterness. The intensity of the off-flavours was evaluated from weak to strong on a scale between 1 to 5. For the desirable properties evaluated, i.e., overall aroma and sourness, the measurement scale was also 1 to 5 but in an ascending order of preference/likeliness. The results are shown in the Table 5.

TABLE 5
pH and sensory score of samples taken at
different time point during fermentation

| Sample time | 2 h | 4 h | 6 h | 8 h |
|---|---|---|---|---|
| pH | 5.99 | 4.82 | 4.56 | 4.43 |
| Overall aroma | 3 | 4 | 5 | 3 |
| Sour | 1 | 2 | 3 | 5 |
| Sweetness | 4 | 3 | 2 | 1 |
| Beany flavour | 2 | 2 | 1 | 1 |
| Grassy flavour | 2 | 1 | — | — |
| Bitterness | 2 | 1 | 1 | 1 |

The results indicate that the overall aroma profile was improved by fermentation. The pH and sour taste increased while the sweetness reduced during fermentation. These were desired changes. Samples fermented for 6 hours were found to be the most acceptable. In these samples the pH reached 4.56 while the acidity and sweetness were relatively balanced.

The beany flavour and bitterness also decreased during fermentation, both remaining very mild after a 6-hour fermentation. Beyond 6 hours, excessive culture activity resulted in an unfavourable taste profile.

### Example 5: Coagulation of Fermented Plant-Based Beverages

The fermented white lentil food product of the invention is unique in that it does not undergo any visible protein coagulation/curd formation, even when heated. Without being bound by theory, it is thought that this advantageous property is a function of the particular proteins present in the white lentils.

In this experiment, fermented beverages were made from a variety of lentils/beans using the basic process of the invention, substituting the white lentil component for mung bean, white pea and chickpea to form three comparative fermented plant-based beverages. The coagulation tendencies of these beverages were observed during the fermentation process.

The gel strength in terms of storage and loss modulus (G′ & G″ values) was measured in a rotational Anton Paar Physica MCR 301 stress-controlled rheometer (Anton Paar, Graz, Austria), equipped with a starch stirrer cell (ST24-2D/2V/2V-30).

20 ml of the white lentil beverage Sample A prepared in Example 2 was premixed with yogurt culture YC-380 (Chr Hansen, Denmark) at 0.002% (w/v) and loaded into the starch cell cup.

A time sweep measurement was performed at a frequency 1 Hz with a strain 1% while maintaining the temperature at 45° C. to monitor any curd formation. The G′ and G″ values were recorded at every 2 min for 6 h. The pH of all the samples were measured at the end for experiment.

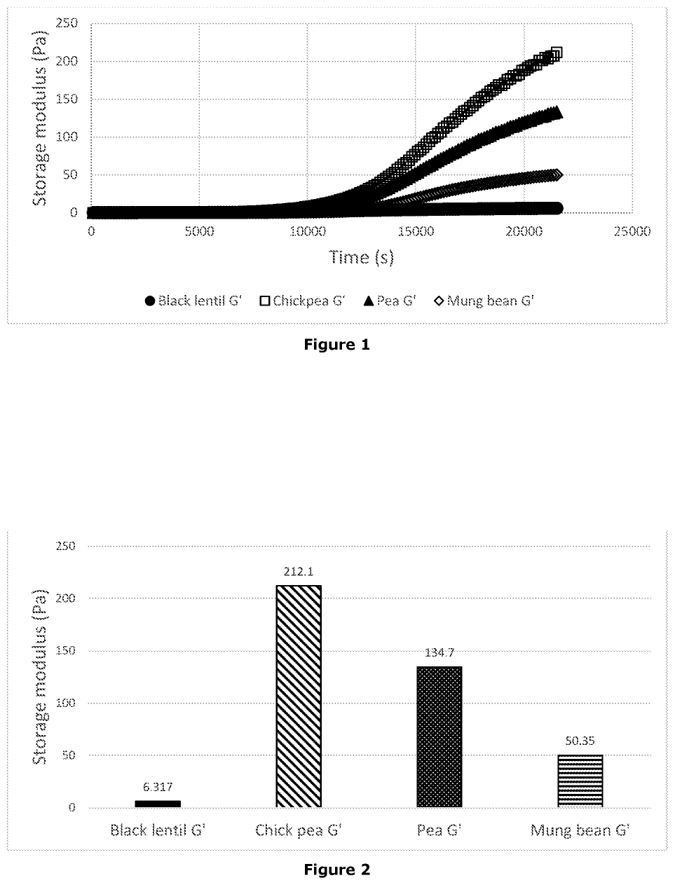

The results are shown in FIGS. 1 and 2. FIG. 1 shows the developing G′ values over the test period which directly represent the gel strength of the samples indicating the degree of coagulum formation. FIG. 2 shows the absolute G′ values of the samples at the end of the experiment.

It was observed that the initial values at Time 0 for all the samples were close to zero indicating the absence of any coagulation due to the processing of the unfermented beverages. As the fermentation progressed and the pH started dropping due to the culture activity, from 2 hr onwards, distinctive curd formation was observed in the chickpea sample. For the mung bean and the pea samples, curd formation started from nearly 3 hr onwards. After 6 hr, maximum gel strength was recorded for the chickpea sample (final G′ 212.1 Pa, FIG. 2) followed by pea (G′ 134.7 Pa) and mung bean (G′ 50.4 Pa). The fermented white lentil sample had the weakest and probably negligible gel strength with a final G′ value of only 6.3 Pa, clearly indicating the absence of any coagulum despite the significant development of acidity (pH ˜4.5) by the fermenting cultures.

The curd formation phenomenon in the samples other than white lentil, during the fermentation process, was also confirmed by inspecting the change in particle sizes before and after the fermentation.

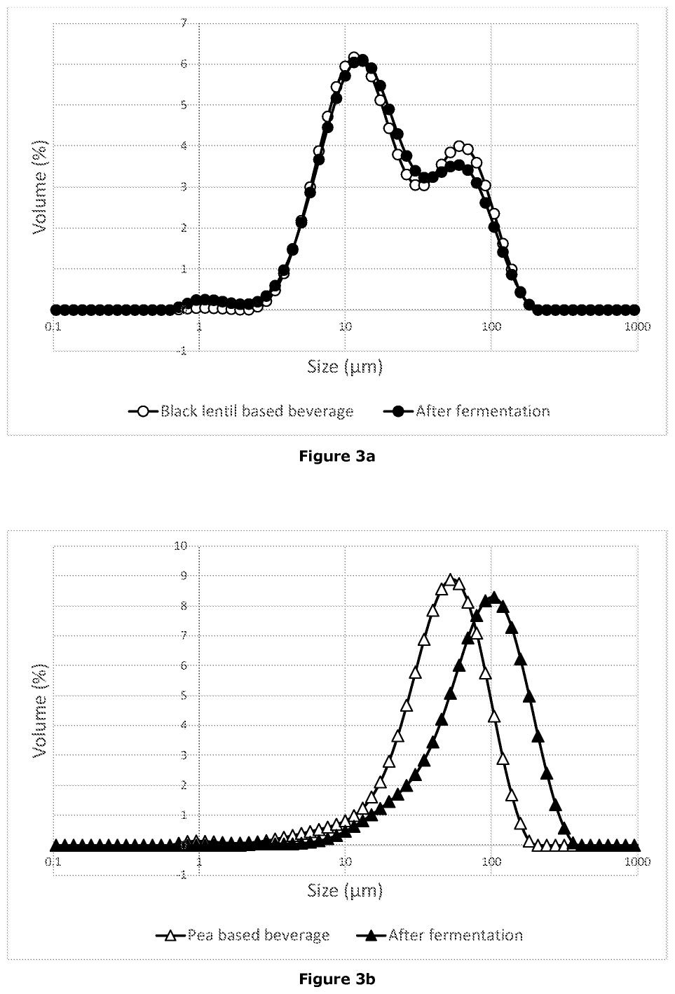

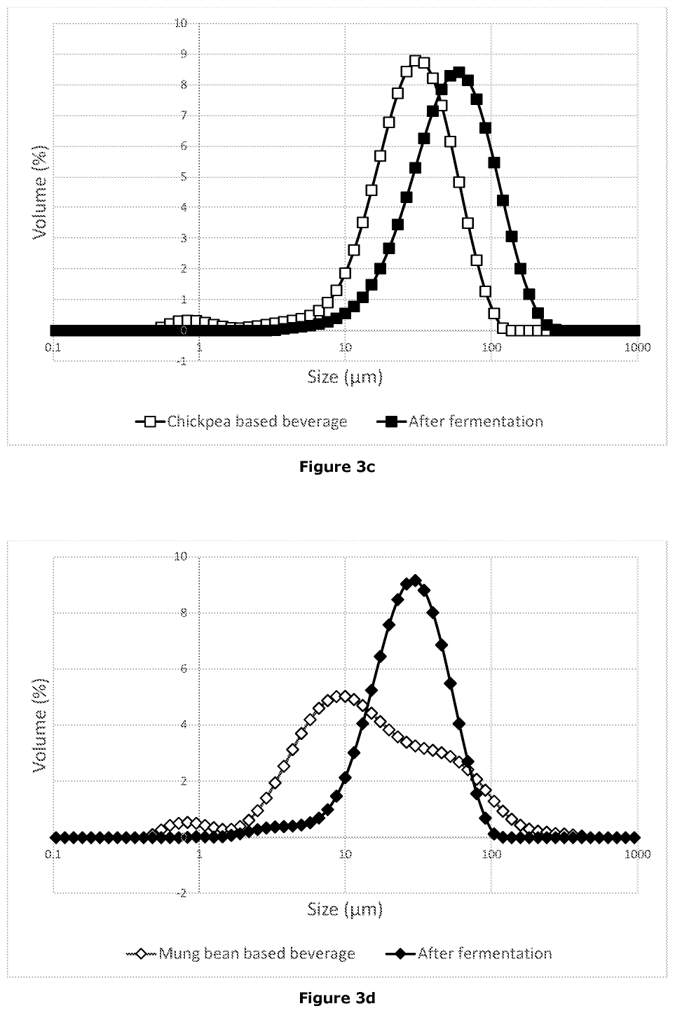

The particle size distributions of fermented and unfermented samples were measured in the Mastersizer 2000 (Malvern Instruments Ltd., Worcestershire, UK) instrument. Each sample was diluted 5 times with distilled water and stirred evenly. A few drops of diluted samples were added to the recirculating distilled water (2000 rpm, obscuration 10-12%) to measure the droplet size. The refractive index of 1.53 was used as reference. Each sample was measured 3 times. FIGS. 3a to 3d show the particle size distributions and more importantly, the shift in mean particle sizes during this process.

FIGS. 3a-3d clearly show that in all the samples except the fermented white lentil beverage, the distribution peak was shifted to the right, meaning that the mean particle size of the samples became higher. This indicates the aggregation of proteins which in turn were responsible for the curd formations in those samples. The white lentil samples showed no significant difference in either the distribution pattern or in the mean particle sizes before and after the fermentation. This finding again confirmed the absence of any coagulation in the fermented white lentil beverages of the invention.

TABLE 6
Mean particle sizes before and after the fermentation process

| | D [4, 3] | D [3, 2] | d (0.5) |
|---|---|---|---|
| Sample | (μm) | (μm) | (μm) |
| Pea | 49.663 | 24.164 | 44.567 |
| Fermented pea | 91.486 | 50.76 | 80.816 |
| Chickpea | 30.625 | 13.891 | 27.024 |
| Fermented chickpea | 58.6 | 37.337 | 50.309 |
| Black lentil | 30.175 | 12.797 | 16.591 |
| Fermented black lentil | 28.402 | 11.035 | 16.184 |
| Mung bean | 25.362 | 6.708 | 12.492 |
| Fermented mung bean | 28.551 | 17.991 | 25.331 |

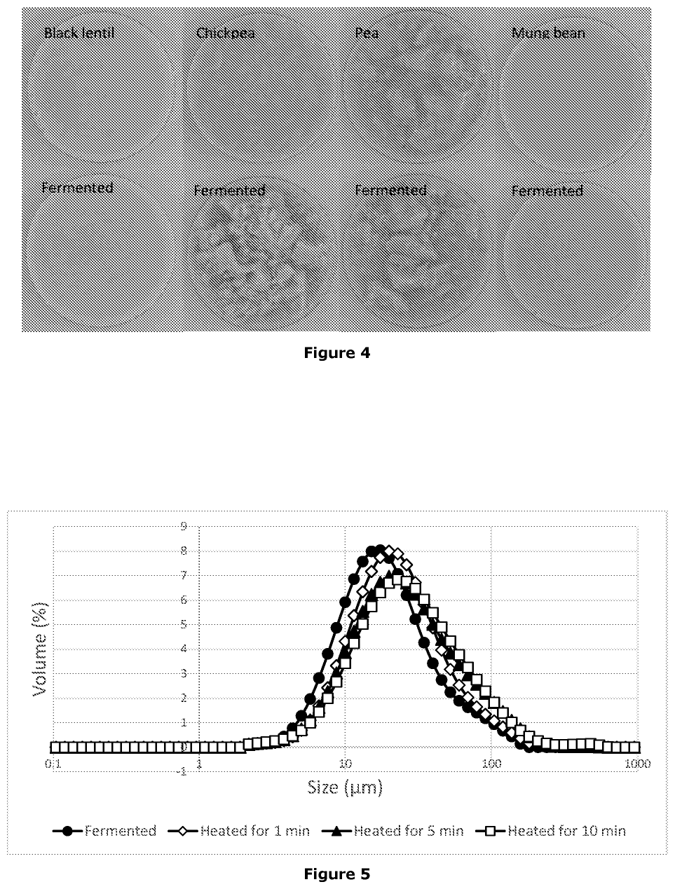

FIG. 4 shows photographs of the samples before and after the fermentation process.

No visible curd formation can be observed in the white lentil and the mung bean samples from this photograph. However, the rheological studies presented earlier confirm curd formation in the fermented mung bean sample.

Strong curd formations in both the unfermented and fermented samples of pea and chickpea can be seen. The curd formation in the unfermented samples was probably due to heat coagulation of the proteins during the pressure cooking process.

As can be observed in FIG. 4, the fermented white lentil beverage is also the whitest of the samples. The reflected colours of each of the fermented and unfermented beverages were measured in a chroma meter using the colorimetric principles (Minolta CR-400, Minolta Camera Co., Osaka, Japan). Whole (full fat) cow milk was used as a control.

The samples were loaded in the clear plastic petri dishes with 2 cm thickness. The petri dishes with samples were placed on the monitor of the colorimeter to measure and record the reflections. Each sample was measured 3 times at different positions.

The colour of each samples is defined and presented using the CIELAB colour system (L*, a*, b*) in Table 5. The CIELAB colour space (also known as CIE L*a*b*) is a colour space defined by the International Commission on Illumination (CIE) in 1976. This system expresses colour as three values: L* for the lightness from black (0) to white (100), a* from green (−) to red (+), and b* from blue (−) to yellow (+). CIELAB was designed so that the same amount of numerical change in these values corresponds to roughly the same amount of visually perceived change.

The instrumental measurement of the colour parameters of each of these samples are presented in Table 7 below.

TABLE 7
Colour measurement data of the experimental
samples compared with full fat cow milk

| Sample | L* | a* | b* |
|---|---|---|---|
| Whole cow milk | 89.77 | −3.79 | 10.01 |
| White lentil | 81.97 | −1.83 | 5.51 |
| Fermented white lentil | 82.54 | −1.70 | 5.51 |
| Chickpea | 81.92 | −2.17 | 13.99 |
| Fermented chickpea | 81.03 | −1.86 | 14.51 |
| Pea | 78.88 | −1.38 | 13.64 |
| Fermented pea | 78.32 | −1.14 | 13.76 |
| Mung been | 81.06 | −4.40 | 17.40 |
| Fermented mung bean | 80.14 | −4.41 | 17.13 |

Table 7 shows that the whiteness of all the samples measured by the L* values were close to each other within a narrow range. Cow milk was found to be the whitest while both the pea samples were least white. The rest of the samples were close to each other but much less white then cow milk. The negative a* values indicated a greenish tone according to which the white lentil and the pea samples were least green whereas the mung bean was the greenest.

The most important finding was the b* values which represents yellowness. The white lentil samples were found to be significantly less yellow than all the other samples, including the cow milk. The yellowness of the pea, chickpea and mung bean samples was even much higher than cow milk, which is known for its yellowness due to the presence of carotene.

Overall, it can be concluded that the fermented white lentil beverages of the invention have good whiteness with less green and yellow tones, thus making them close to milk in appearance.

### Example 6: Heat Stability of Fermented White Lentil Beverage of the Invention

Samples of fermented white lentil beverage were prepared in accordance with Example 1. The samples were then heated to 95° C. and held at that temperature for up to 10 min.

Samples were removed at 1 min, 5 min and 10 min intervals. Heated samples were stored at 4° C. for overnight. As a control, the fermented mung bean beverage prepared in Example 5 was also tested. The pea and chickpea beverages were not used in this study because Example 5 had shown that they formed very strong curd during the fermentation process itself, hence syneresis was obvious during further heat treatment.

In Example 5, it was shown that the change in particle size distribution and peak shifting phenomenon offered good insights into the curd forming action by protein aggregation. Therefore, these parameters were thought to act as a good proxy for the rheological study showing increasing gel strength. Hence, in this experiment only the particle size distributions of the fermented beverage samples before and after the heat treatment were studied. The measurement protocol was same as described above in Example 5.

FIG. 5 shows the changes in particle size distributions of the fermented white lentil beverage due to heat treatment at 95° C. for different time durations.

Table 8 shows that the average particle sizes (surface based, volume based) of the white lentil beverage increased marginally due to the heating process. Holding for a longer duration resulted in slightly bigger mean sizes, indicating mildly higher level of protein aggregation.

FIG. 5 showing the overall size distributions is also in agreement with this finding where minor shifts towards the right side were noticed.

TABLE 8
Mean particle size of fermented white lentil
beverage following heat treatment

| | D [4, 3] | D [3, 2] | d (0.5) |
|---|---|---|---|
| Sample | (μm) | (μm) | (μm) |
| Fermented black lentil (control) | 23.151 | 13.63 | 16.538 |
| Fermented black lentil heated for 1 min | 27.79 | 16.094 | 20.146 |
| Fermented black lentil heated for 5 min | 32.946 | 17.126 | 22.36 |
| Fermented black lentil heated for 10 min | 36.102 | 17.91 | 24.069 |

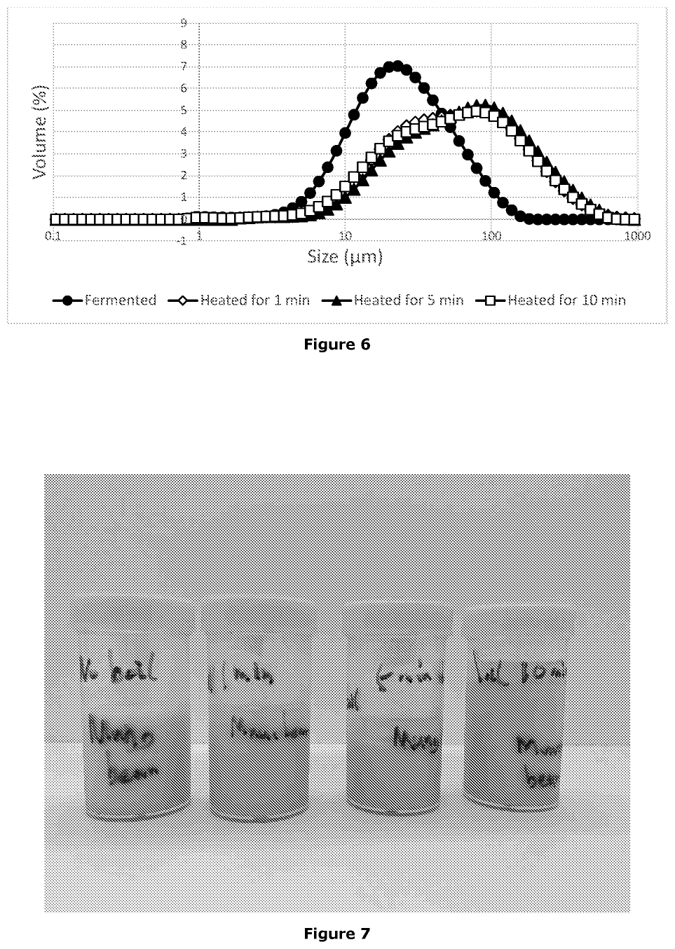

However, for the heated fermented mung bean beverage samples (Table 7 and FIG. 6), the mean particle sizes increased significantly, indicating much higher levels of protein aggregation, curd formation and resulting emulsion instability.

TABLE 9
Mean particle size of fermented mung bean
beverage after the heat treatment

| | D [4, 3] | D [3, 2] | d (0.5) |
|---|---|---|---|
| Sample | (μm) | (μm) | (μm) |
| Fermented mung bean (control) | 28.742 | 15.257 | 21.7 |
| Fermented mung bean heated for 1 min | 83.625 | 31.68 | 53.733 |
| Fermented mung bean heated for 5 min | 92.732 | 34.623 | 62.008 |
| Fermented mung bean heated for 10 min | 80.916 | 26.763 | 52.773 |

The size distribution graphs in FIG. 6 were also significantly shifted towards the right following heat treatment at 95° C. for different time durations.

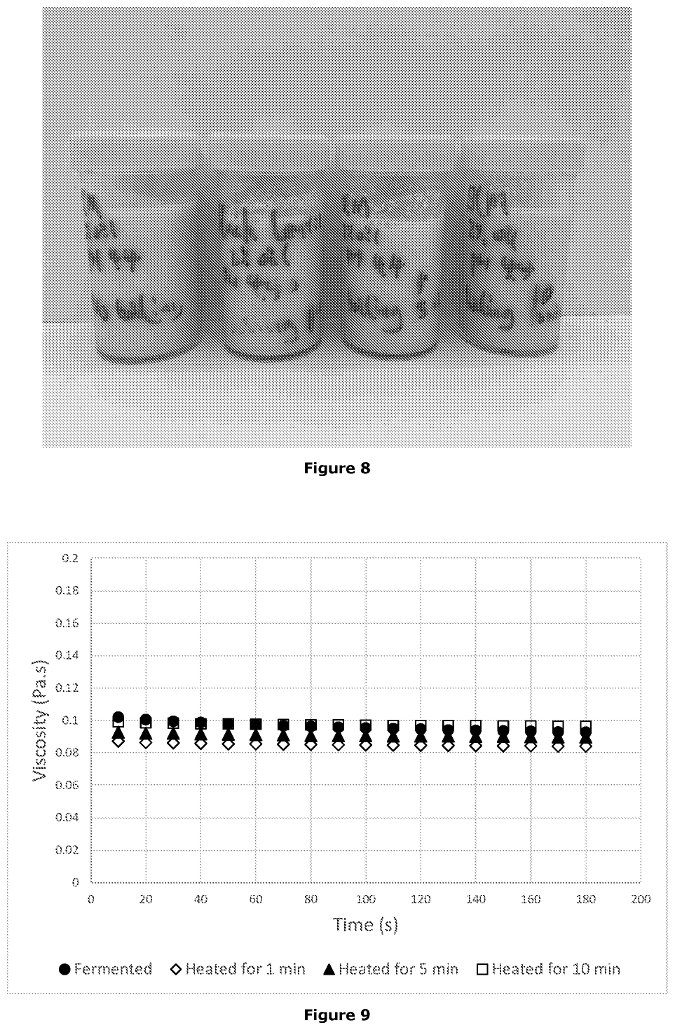

The emulsion instability in this case was also confirmed by the photographs presented in FIGS. 7 and 8 where visible water separation (syneresis) was observed after overnight storage of the heated fermented mung bean beverage (FIG. 7). In the case of the heated fermented white lentil beverages (FIG. 8) such syneresis was found to be negligible.

These results confirmed the better heat stability and lower syneresis properties of the fermented white lentil beverage indicating its suitability as a shelf-stable, plant-based fermented beverage similar to the highly popular drinkable yogurts available in the market.

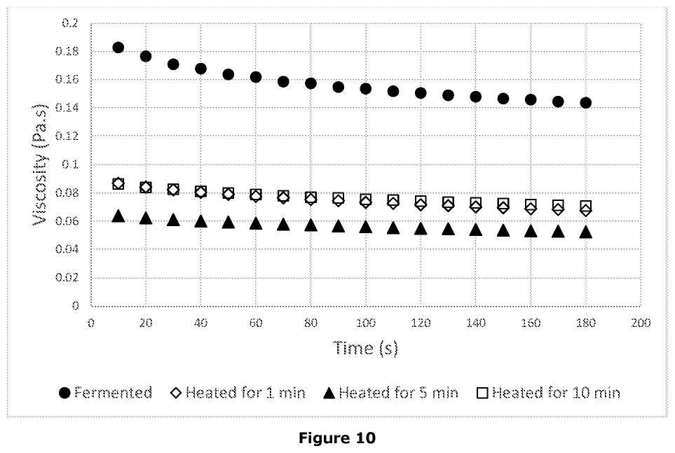

In addition to the particle size distribution measurement, the viscosity change in the same set of samples described above was also measured before and after the heat treatment. For this, the AR-G2 magnetic bearing rheometer (TA Instruments, Crawley, West Sussex, UK), equipped with a standard Peltier Concentric Cylinder System (combines a 15 mm radius cup and a 14 mm radius rotor) was used. The measurement was conducted at 15° C. and a constant shear rate 50 s-1 was applied. Viscosity was recorded every 10 s for 3 min duration of the experiment. Each sample was measured in triplicate and the mean values are presented in FIGS. 9 and 10.

FIG. 9 shows the change in viscosity of the fermented white lentil beverage due to heat treatment followed by overnight storage. After heat treatment and holding for different time periods, followed by overnight storage, the white lentil beverage samples show almost no change in the viscosity (FIG. 9) compared to the unheated sample, indicating a near Newtonian fluid character and a stable emulsion.

Emulsion stability is a desirable property which is difficult to achieve in any plant-based beverage where solid (from beans/lentils) and liquid (water) phases are brought together. The stability of the liquid end-product is largely dependent on the intrinsic character (e.g. the emulsifying property of the plant protein used) of the constituents. Instability or improper emulsion system leads to the phase separation or syneresis during storage and should be avoided at all cost. No significant alteration in the viscosity of the fermented white lentil beverage samples indicated no change in the emulsion stability due to the extreme heat treatment. This was also supported by the absence of any visual phase separation as shown in FIG. 7.

The absence of phase separation seen in the fermented white lentil beverage can be contrasted with the fermented mung bean beverage in which the change in viscosity was clearly noticeable (FIG. 10). Without being bound by theory, it is thought that the protein hydration was inadequate to bind the free water and impart the desired stability. This resulted in clear phase separation as also is evident from FIG. 9. In the fermented mung bean beverage, the proteins were already destabilized and formed a light coagulum during the fermentation process (as explained in Example 4). This disruption of the protein native state may have caused the mung bean proteins to lose their emulsifying and stabilizing properties.

1. A process for preparing a fermented white lentil beverage, the process comprising:
(a) soaking white lentils in water for at least about 30 min,
(b) removing the water from step (a) and adding new water to provide a mixture of white lentils and water in a wt ratio of about 1:20 to about 1:1,
(c) cooking the mixture of step (b) under pressure for about 10 to about 40 min,
(d) forming a paste from the cooked lentil mixture and adjusting the solid content of the paste to be about 7 to about 20 wt % before wet milling the resulting slurry,
(e) filtering the wet milled slurry of step (d) through a 10-150 micron membrane and incubating the slurry with amylase enzyme at a temperature at which the enzyme is active to reduce the starch content of the slurry,
(f) inactivating the amylase enzyme by heating, to produce a white lentil beverage, and
(g) inoculating the white lentil beverage with a lactic acid bacterial culture and incubating until the beverage reaches a pH of about 4.3 to about 4.6.

2. The process according to claim 1 wherein whole white lentils are soaked for at least 30 minutes in step (a) in water of about 95° C. or crushed white lentils are soaked for at least 30 minutes in step (a) in water at about 4 to about 50° C.

3. The process according to claim 1 wherein the mixture of step (b) is cooked at about 100 to about 140° C. in step (c), preferably at about 110 to about 130° C., more preferably at about 115 to about 125° C.

4. The process according to claim 1 wherein the white lentil paste in step (d) is wet milled in a colloid mill.

5. The process according to claim 1 wherein about 0.01 w/v % to 0.5 w/v % amylase enzyme is added in step (e), preferably 0.1 w/v %.

6. The process according to claim 1 wherein the slurry is heated at 65° C. in step (e).

7. The process according to claim 1 wherein the wet milled slurry of step (d) is filtered through a 100 micron membrane in step (e).

8. The process according to claim 1 wherein the starch content is reduced to less than about 5 wt % in step (e).

9. The process according to claim 1 wherein about 0.1 to about 4 w/v % edible oil is added prior to or following step (f), preferably about 0.1 to about 3 w/v %.

10. The process according to claim 1 wherein the white lentil beverage is incubated with a lactic acid bacterial culture selected from the group consisting of Lactococcus lactis, Lactobacillus species, Streptococcus thermophilus, Bifidobacterium species, and Leuconostoc species.

11. The process according to claim 1 wherein the white lentil beverage is incubated with a commercial yogurt culture comprising selected strains of Lactobacillus bulgaricus and Streptococcus thermophillus bacteria.

12. The fermented white lentil beverage prepared according to the process of claim 1.

13. A fermented white lentil beverage of pH of about 4.3 to about 4.6, comprising about 5 to about 15 wt % carbohydrate, about 2 to about 4.5 wt % edible oil and about 1.0 to about 2.5 wt % white lentil protein.

14. The fermented white lentil beverage of claim 13 comprising about 7 to about 10 wt % carbohydrate and 2 to about 3.5 wt % edible oil.

15. The fermented white lentil beverage of claim 13 comprising about 1.2 to about 2.0 wt % white lentil protein, preferably about 1.5 to about 1.8, 1.9 or 2.0 wt % white lentil protein.

16. The fermented white lentil beverage of claim 13 in which the white lentil protein is substantially non-aggregated.

17. The fermented white lentil beverage of claim 13 in which the average particle size is less than 100 μm.

18. The fermented white lentil beverage of claim 13 which does not contain any added stabilising agents.

19. The fermented white lentil beverage of claim 13 which is stable when heated to about 90-95° C. for about 3-5 minutes.

20. The fermented white lentil beverage of claim 13 in which the proteins of the fermented white lentil beverage do not substantially aggregate when heated to about 90-95° C. for about 3-5 minutes.
